(19) United States
(12) Patent Application Publication
(10) Pub. No.: US 2026/0025833 A1
(43) Pub. Date: Jan. 22, 2026

(54) SHARED CHANNEL PIGGYBACKING

(71) Applicant: QUALCOMM Incorporated, San Diego, CA (US)

(72) Inventors: Morteza SOLTANI, San Diego, CA (US); Jing SUN, San Diego, CA (US); Jing JIANG, San Diego, CA (US)

(21) Appl. No.: 18/778,852

(22) Filed: Jul. 19, 2024

(51) Int. Cl. H04W 72/232

(52) U.S. Cl. CPC H04W 72/232

(57) ABSTRACT

Methods, systems, and devices for wireless communication are described. A network entity may switch between low density parity check (LDPC) and polar encoding schemes depending on the payload size of the DCI components and how the DCI components are bundled (i.e., jointly or separately). The switching between LDPC and polar encoding schemes may be based on a payload size threshold. This threshold may be hard coded or it may be semi-statically configured using radio resource control (RRC) signaling.

### FIELD OF TECHNOLOGY

The following relates to wireless communications, including shared channel piggybacking.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include generating one or more downlink control information (DCI) components for one or more user equipment (UEs), multiplexing the one or more DCI components with downlink shared data for the one or more UEs based on a quantity of the one or more DCI components exceeding a quantity threshold, an aggregated size of the one or more DCI components exceeding a payload size threshold, or both, and outputting a downlink shared channel including the one or more DCI components multiplexed with the downlink shared data for the one or more UEs.

A network entity for wireless communications is described. The network entity may include one or more memories storing processor executable code, and one or more processors coupled with the one or more memories. The one or more processors may individually or collectively be operable to execute the code to cause the network entity to generate one or more DCI components for one or more UEs, multiplex the one or more DCI components with downlink shared data for the one or more UEs based on a quantity of the one or more DCI components exceeding a quantity threshold, an aggregated size of the one or more DCI components exceeding a payload size threshold, or both, and output a downlink shared channel including the one or more DCI components multiplexed with the downlink shared data for the one or more UEs.

Another network entity for wireless communications is described. The network entity may include means for generating one or more DCI components for one or more UEs, means for multiplexing the one or more DCI components with downlink shared data for the one or more UEs based on a quantity of the one or more DCI components exceeding a quantity threshold, an aggregated size of the one or more DCI components exceeding a payload size threshold, or both, and means for outputting a downlink shared channel including the one or more DCI components multiplexed with the downlink shared data for the one or more UEs.

A non-transitory computer-readable medium storing code for wireless communications is described. The code may include instructions executable by one or more processors to generate one or more DCI components for one or more UEs, multiplex the one or more DCI components with downlink shared data for the one or more UEs based on a quantity of the one or more DCI components exceeding a quantity threshold, an aggregated size of the one or more DCI components exceeding a payload size threshold, or both, and output a downlink shared channel including the one or more DCI components multiplexed with the downlink shared data for the one or more UEs.

In some examples of the method, network entities, and non-transitory computer-readable medium described herein, generating the one or more DCI components may include operations, features, means, or instructions for generating the one or more DCI components with a common cyclic redundancy check.

Some examples of the method, network entities, and non-transitory computer-readable medium described herein may further include operations, features, means, or instructions for encoding the one or more DCI components with a low density parity check code based on the aggregated size of the one or more DCI components exceeding the payload size threshold.

Some examples of the method, network entities, and non-transitory computer-readable medium described herein may further include operations, features, means, or instructions for encoding the one or more DCI components with a polar code based on the aggregated size of the one or more DCI components being less than the payload size threshold.

In some examples of the method, network entities, and non-transitory computer-readable medium described herein, generating the one or more DCI components may include operations, features, means, or instructions for segmenting an aggregation of the one or more DCI components into a set of multiple DCI segments, where each of the set of multiple DCI segments may be associated with a respective cyclic redundancy check.

Some examples of the method, network entities, and non-transitory computer-readable medium described herein may further include operations, features, means, or instructions for encoding one or more DCI segments of the set of multiple DCI segments with a low density parity check code based on a respective payload size of each of the one or more DCI segments exceeding the payload size threshold.

Some examples of the method, network entities, and non-transitory computer-readable medium described herein may further include operations, features, means, or instructions for encoding one or more DCI segments of the set of multiple DCI segments with a polar code based on a respective payload size of each of the one or more DCI segments being less than the payload size threshold.

Some examples of the method, network entities, and non-transitory computer-readable medium described herein may further include operations, features, means, or instructions for encoding each of the set of multiple DCI segments with a low density parity check code based on a maximum payload size associated with the set of multiple DCI segments exceeding the payload size threshold.

Some examples of the method, network entities, and non-transitory computer-readable medium described herein may further include operations, features, means, or instructions for encoding each of the set of multiple DCI segments with a polar code based on a minimum payload size of the set of multiple DCI segments being less than the payload size threshold.

In some examples of the method, network entities, and non-transitory computer-readable medium described herein, zero padding one or more DCI segments of the set of multiple DCI segments based on the one or more DCI segments having a different payload size than a remaining quantity of DCI segments of the set of multiple DCI segments.

Some examples of the method, network entities, and non-transitory computer-readable medium described herein may further include operations, features, means, or instructions for receiving an indication of the quantity threshold and the payload size threshold via radio resource control signaling.

A method for wireless communications by a user equipment (UE) is described. The method may include receiving a downlink shared channel including one or more DCI components multiplexed with downlink shared data based on a quantity of the one or more DCI components exceeding a quantity threshold, an aggregated size of the one or more DCI components exceeding a payload size threshold, or both and decoding the one or more DCI components, the downlink shared data, or both, to obtain downlink control information, shared data, or both for the UE.

A UE for wireless communications is described. The UE may include one or more memories storing processor executable code, and one or more processors coupled with the one or more memories. The one or more processors may individually or collectively be operable to execute the code to cause the UE to receive a downlink shared channel including one or more DCI components multiplexed with downlink shared data based on a quantity of the one or more DCI components exceeding a quantity threshold, an aggregated size of the one or more DCI components exceeding a payload size threshold, or both and decode the one or more DCI components, the downlink shared data, or both, to obtain downlink control information, shared data, or both for the UE.

Another UE for wireless communications is described. The UE may include means for receiving a downlink shared channel including one or more DCI components multiplexed with downlink shared data based on a quantity of the one or more DCI components exceeding a quantity threshold, an aggregated size of the one or more DCI components exceeding a payload size threshold, or both and means for decoding the one or more DCI components, the downlink shared data, or both, to obtain downlink control information, shared data, or both for the UE.

A non-transitory computer-readable medium storing code for wireless communications is described. The code may include instructions executable by one or more processors to receive a downlink shared channel including one or more DCI components multiplexed with downlink shared data based on a quantity of the one or more DCI components exceeding a quantity threshold, an aggregated size of the one or more DCI components exceeding a payload size threshold, or both and decode the one or more DCI components, the downlink shared data, or both, to obtain downlink control information, shared data, or both for the UE.

In some examples of the method, UEs, and non-transitory computer-readable medium described herein, receiving the one or more DCI components may include operations, features, means, or instructions for receiving the one or more DCI components with a common cyclic redundancy check.

In some examples of the method, UEs, and non-transitory computer-readable medium described herein, receiving the one or more DCI components may include operations, features, means, or instructions for receiving the one or more DCI components encoded with a low density parity check code, the encoding based on the aggregated size of the one or more DCI components exceeding the payload size threshold.

In some examples of the method, UEs, and non-transitory computer-readable medium described herein, receiving the one or more DCI components may include operations, features, means, or instructions for receiving the one or more DCI components encoded with a polar code, the encoding based on the aggregated size of the one or more DCI components being less than the payload size threshold.

In some examples of the method, UEs, and non-transitory computer-readable medium described herein, receiving the one or more DCI components may include operations, features, means, or instructions for receiving the one or more DCI components via a set of multiple DCI segments, where each of the set of multiple DCI segments may be associated with a respective cyclic redundancy check.

Some examples of the method, UEs, and non-transitory computer-readable medium described herein may further include operations, features, means, or instructions for receiving one or more DCI segments of the set of multiple DCI segments encoded with a low density parity check code, the low density parity check code based on a respective payload size of each of the one or more DCI segments exceeding the threshold payload size.

Some examples of the method, UEs, and non-transitory computer-readable medium described herein may further include operations, features, means, or instructions for receiving one or more DCI segments of the set of multiple DCI segments encoded with a polar code, the polar code based on a respective payload size of each of the one or more DCI segments being less than the payload size threshold.

Some examples of the method, UEs, and non-transitory computer-readable medium described herein may further include operations, features, means, or instructions for receiving each of the set of multiple DCI segments encoded with a low density parity check code, the encoding based on a maximum payload size associated with the set of multiple DCI segments exceeding the payload size threshold.

Some examples of the method, UEs, and non-transitory computer-readable medium described herein may further include operations, features, means, or instructions for receiving each of the set of multiple DCI segments encoded with a polar code, the encoding based on a minimum payload size of the set of multiple DCI segments being less than the payload size threshold.

In some examples of the method, UEs, and non-transitory computer-readable medium described herein, one or more DCI segments of the set of multiple DCI segments may be zero padded based on the one or more DCI segments having a different payload size than a remaining quantity of DCI segments of the set of multiple DCI segmenting.

Some examples of the method, UEs, and non-transitory computer-readable medium described herein may further include operations, features, means, or instructions for transmitting an indication of the quantity threshold and the payload size threshold via radio resource control signaling.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports shared channel piggybacking in accordance with one or more aspects of the present disclosure.

FIG. 2 shows an example of a wireless communications that supports shared channel piggybacking in accordance with one or more aspects of the present disclosure.

FIGS. 3A and 3B show examples of data diagrams that support shared channel piggybacking in accordance with one or more aspects of the present disclosure.

FIG. 4 shows an example of a flow diagram that supports shared channel piggybacking in accordance with one or more aspects of the present disclosure.

FIGS. 5 and 6 show block diagrams of devices that support shared channel piggybacking in accordance with one or more aspects of the present disclosure.

FIG. 7 shows a block diagram of a communications manager that supports shared channel piggybacking in accordance with one or more aspects of the present disclosure.

FIG. 8 shows a diagram of a system including a device that supports shared channel piggybacking in accordance with one or more aspects of the present disclosure.

FIGS. 9 and 10 show block diagrams of devices that support shared channel piggybacking in accordance with one or more aspects of the present disclosure.

FIG. 11 shows a block diagram of a communications manager that supports shared channel piggybacking in accordance with one or more aspects of the present disclosure.

FIG. 12 shows a diagram of a system including a device that supports shared channel piggybacking in accordance with one or more aspects of the present disclosure.

FIGS. 13 and 14 show flowcharts illustrating methods that support shared channel piggybacking in accordance with one or more aspects of the present disclosure.

### DETAILED DESCRIPTION

In some wireless communications systems, downlink grants for downlink communications (from the network entity to the UE) and/or uplink grants for uplink communications (from the UE to the network entity) may be scheduled for a user equipment (UE) via DCI, which may be transmitted from a network entity to the UE. The DCI may be received via control resource sets (CORESETs), which may be blindly decoded by the UE. In high-frequency bands, slot duration may decrease and the number of slots per subframe may increase. This may correspondingly increase a quantity of CORESETs that the UE may monitor and blindly decode for DCI received via the respective CORESETs. Increased search space monitoring, in conjunction with increased blind decoding, may result in excessive computational complexity and cost, as well as increased power consumption at the UE.

One option for addressing issues associated with increased blind decoding is the concept of “piggyback” DCI. With piggyback DCI, scheduled downlink transmissions (e.g., physical downlink shared channel (PDSCH) transmissions) may be formatted to include downlink data messages (e.g., downlink data within a transport block) multiplexed with additional DCI (e.g., piggyback DCI).

With piggyback DCI, the DCI components for a particular PDSCH transmission may either be encoded separately or jointly. When DCI components are encoded separately, the payload of each DCI component may be associated with a respective cyclic redundancy check (CRC). When DCI components are encoded jointly, the payloads for all the DCI components are aggregated and one CRC is attached or appended to the aggregated payload (e.g., a coded block). However, if DCI components are encoded jointly and the aggregated payload exceeds a threshold size, encoders such as those utilizing low density parity check (LDPC) coding may result in a higher coding gain compared to polar codes. If DCI components are encoded separately, each DCI component may have a relatively small payload (e.g., a payload below a threshold size), and polar coding may provide better coding gain as compared to LDPC coding. If the payload of each DCI component is exceeds a threshold payload size and a separate encoding is used, an LDPC encoder may be selected due to a higher coding gain for larger block lengths relative to polar encoding.

To determine a forward error correction method for various piggybacked DCI, a network entity may consider both coding gain and implementation complexity. In some examples, a network entity may switch between LDPC and polar encoding schemes depending on the payload size of the DCI components and how the DCI components are bundled (e.g., jointly or separately). The switching between LDPC and polar encoding schemes may be based on a payload size threshold.

Aspects of the disclosure are initially described in the context of wireless communications systems. Aspects of the disclosure are further illustrated by and described with reference to system diagrams, data diagrams, and flowcharts Aspects of the disclosure are further illustrated by and described with reference to apparatus diagrams, system diagrams, and flowcharts that relate to shared channel piggybacking.

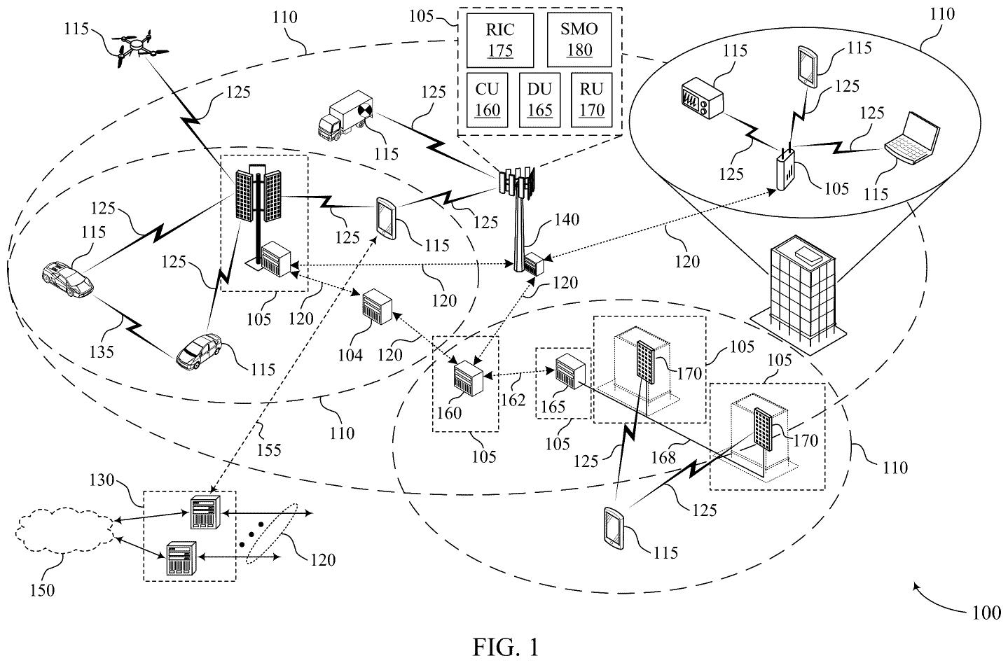

FIG. 1 shows an example of a wireless communications system 100 that supports shared channel piggybacking in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a network entity 105 may switch between LDPC and polar encoding schemes depending on the payload size of the DCI components and how the DCI components are bundled (e.g., jointly or separately). The switching between LDPC and polar encoding schemes may be based on a quantity or a payload size threshold. The quantity or payload size threshold may be preconfigured (e.g., hard coded as part of software, firmware, etc.) or the threshold may be dynamically or semi-statically configured, such as via RRC signaling.

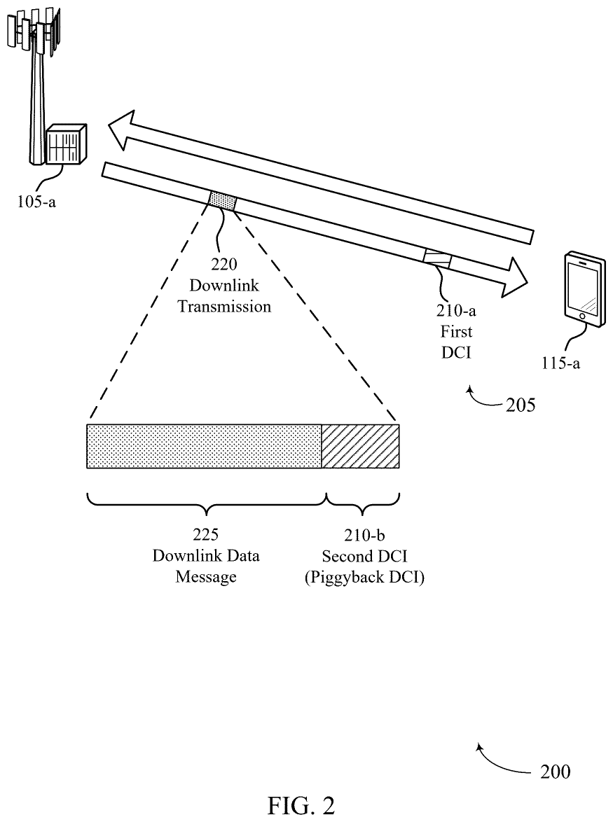

FIG. 2 shows an example of a wireless communications system 200 that supports shared channel piggybacking in accordance with one or more aspects of the present disclosure. The wireless communications system 200 may include a network entity 105-a and a UE 115-a, which may be examples of UEs 115 and network entity 105, as described with reference to FIG. 1.

UE 115-a may communicate with network entity 105-a using a communication link 205. In some cases, communication link 205 may include an example of an access link (e.g., a Uu link). Communication link 205 may include a bi-directional link that can include both uplink and downlink communications. In one aspect, UE 115-a may transmit uplink transmissions, such as uplink messages or uplink signals, to network entity 105-a using communication link 205 and network entity 105-a may transmit downlink data transmissions, such as downlink messages or downlink signals, to UE 115-a using communication link 205. Network entity 105-a may communicate unicast messages with UE 115-a or network entity 105-a may communicate broadcast messages with a plurality of UEs using communication link 205.

In some wireless communication systems 200, DCI may be used for conveying or carrying downlink grants and uplink grants for UE 115-a. The DCI may be carried by a PDCCH and transmitted within a CORESET or other control resources. The UE 115-a may perform blind decoding on one or more decoding candidates in the CORESET to identify DCI that is for UE 115-a. The blind decoding candidates may be organized in search space sets and one or more search space sets may be associated with one CORESET. In some examples, blind decoding may result in a non-negligible processing burden and thus higher complexity for UE 115-a. To reduce blind decoding of PDCCH and enhance DCI transmission efficiency, the DCI may be combined with PDSCH (e.g., piggybacked). Combining the DCI with PDSCH may offload control information from the PDCCH region, reducing the blind decoding otherwise used for the PDCCH. The size of DCI in PDCCH may be limited based on the CORESET size and availability for the UE 115-a.

For example, network entity 105-a may transmit a first DCI 210-a to the UE 115-a. In some examples, first DCI 210-a may schedule a downlink transmission 220 at UE 115-a. In some aspects, downlink transmission 220 may include a downlink data message 225 (e.g., downlink shared channel transmission) which is multiplexed with a second DCI 210-b (e.g., piggyback DCI 210-b). In some aspects, first DCI 210-a may indicate, to UE 115-a, that downlink transmission 220 scheduled by first DCI 210-a includes both downlink data message 225 and second DCI 210-b (e.g., downlink transmission 220 includes downlink data message 225 multiplexed with second DCI 210-b).

Second DCI 210-b may include multiple DCI components. Network entity 105-a may determine to multiplex second DCI 210-b with downlink data message 225 based on a quantity or number of the multiple DCI components exceeding a quantity threshold, an aggregated size of the multiple DCI components exceeding a payload size threshold, or both. Based on the comparison of the multiple DCI components satisfying the threshold, network entity 105-a may determine to multiplex second DCI 210-b with downlink data message 225 (e.g., downlink shared channel transmission) in downlink transmission 220.

The plurality of DCI components of second DCI 210-b may be encoded in various ways. For example, DCI components of second DCI 210-b may be encoded separately, where the payload of each DCI component may be associated with a respective cyclic redundancy check (CRC). Additionally, or alternatively, DCI components of second DCI 210-b may be encoded jointly, where the payload of all the DCI components are aggregated and one CRC is attached to the coded block. Network entity 105-a may switch between LDPC and polar encoding schemes depending on the payload size of the DCI components and how the DCI components are bundled (i.e., jointly or separately). The switching between LDPC and polar encoding schemes may be based on a payload size threshold or a quantity threshold. This threshold may be hard coded or may be semi-statically configured using RRC signaling. The RRC signaling may be from network entity 105-a to UE 115-a or from UE 115-a to network entity 105-a.

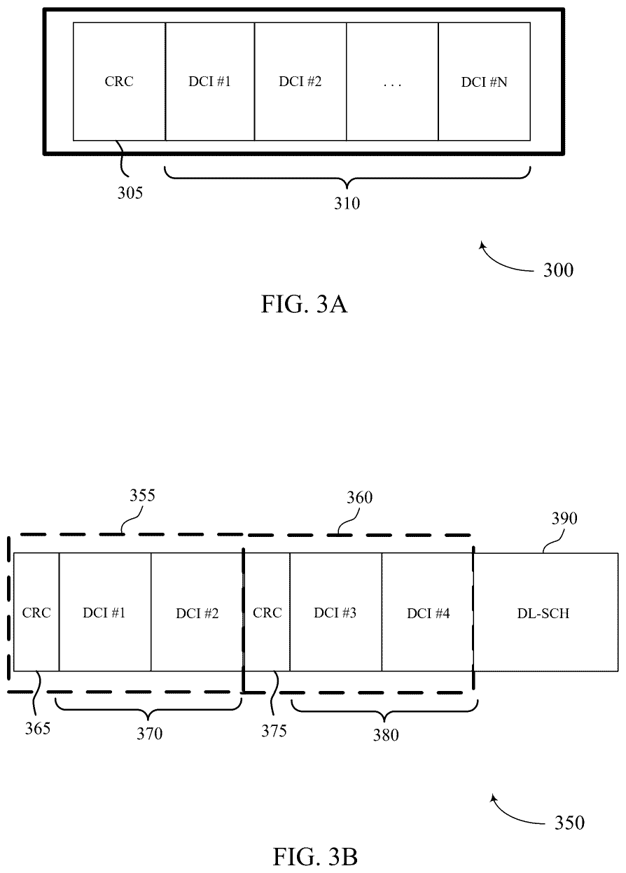

FIGS. 3A and 3B show examples of data diagrams 300 and 350, respectively, that support shared channel piggybacking in accordance with one or more aspects of the present disclosure. Data diagrams 300 and 350 may illustrate portions of second DCI 210-b as described in FIG. 2.

Data diagram 300 of FIG. 3A illustrates an example of DCI components that are encoded jointly. For example, DCI components 310 (DCI #1, DCI #2, . . . . DCI #N) are all aggregated and associated with a CRC 305 (common CRC). In determining if DCI components are encoded using LDPC or polar coding, the aggregated size of DCI components 310 are compared against a payload size threshold. In an example, if the aggregated size of DCI components 310 exceeds the threshold, then DCI components 310 are encoded using LDPC coding. In another example, if the aggregated size of DCI components 310 less than or equal to the threshold, then DCI components 310 are encoded using polar coding.

Data diagram 350 of FIG. 3B illustrates an example of DCI components that are encoded separately. For example, the DCI components of data diagram 350 may be segmented into DCI segment 355 and DCI segment 360. DCI segment 355 may include CRC 365 and DCI components 370 (DCI #1 and DCI #2). DCI segment 360 may include CRC 375 and DCI components 380 (DCI #3 and DCI #4). DCI segment 355 and DCI segment 360 may be piggybacked to downlink shared channel message 390. Although data diagram 350 illustrates two DCI segments, each with two DCI components, there may be any number of DCI segments, and each DCI segment may have any number of DCI components.

DCI segments and DCI components may be compared against a payload size threshold in order to determine if they are encoded using LDPC or polar coding. In a first example, each DCI segment may be encoded with either LDPC or polar encoding. For example, if an aggregate payload of DCI segment 355 is less than or equal to the payload size threshold, then DCI segment 355 is encoded using polar coding. If an aggregate payload of DCI segment 360 is greater than the payload size threshold, then DCI segment 355 is encoded using LDPC coding. Here, DCI segment 355 and DCI segment 360 are encoded using different coding schemes. Downlink shared channel message 390 may be encoded using either coding scheme.

In a second example, both DCI segment 355 and DCI segment 360 are encoded together with either LDPC or polar encoding. For example, a network entity may determine an aggregate payload size of DCI segment 355 and DCI segment 360 combined, and compare the aggregate payload size against the payload size threshold. If the maximum size of the aggregate payload size of DCI segment 355 and DCI segment 360 exceeds the threshold, then both DCI segment 355 and DCI segment 360 may be encoded using LDPC coding. If the minimum size of the aggregate payload size of DCI segment 355 and DCI segment 360 is less than or equal to the threshold, then both DCI segment 355 and DCI segment 360 may be encoded using polar coding. Downlink shared channel message 390 may be encoded using either coding scheme.

In another example, if the payload sizes of DCI segment 355 and DCI segment 360 are different, zero padding may be used to align the sizes of the DCI segments where at least one of the DCI segments are of a different size than at least one other DCI segment. In this case, after zero padding, all the DCI segments are of equal size, and that size is used in comparison to the payload size threshold to determine the encoding scheme.

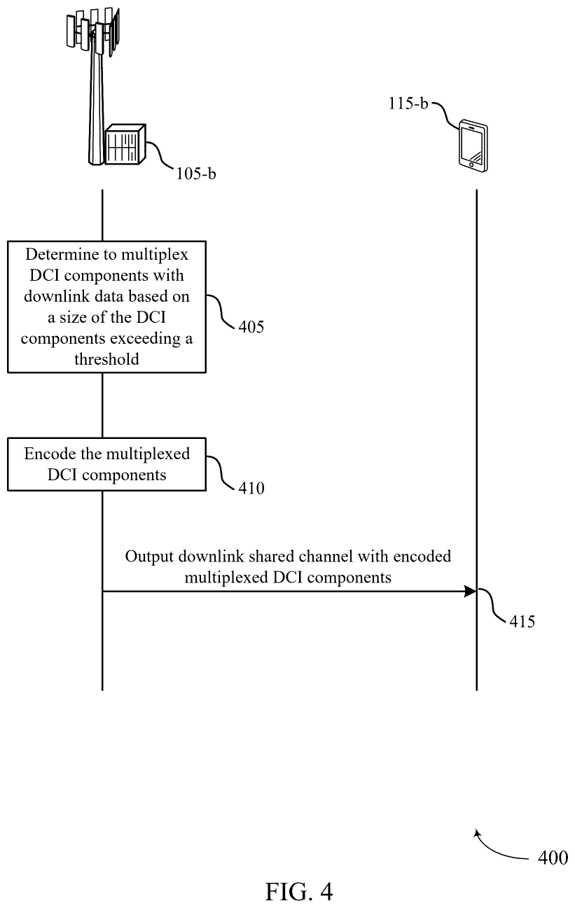

FIG. 4 shows an example of a process flow 400 that supports shared channel piggybacking in accordance with one or more aspects of the present disclosure. The process flow 400 may implement aspects of or may be implemented by aspects of the wireless communications system 100 or the wireless communications system 200. For example, process flow 400 may include one or more UEs 115-b and a network entity 105-b, which may be an example of a UE 115 and a network entity 105 as described herein. In the following description of process flow 400, the operations performed by UE 115-b and network entity 105-b may be performed in different orders or at different times than the exemplary order shown. Some operations may also be omitted from process flow 400, or other operations may be added to process flow 400. Further, while operations in process flow 400 are illustrated as being performed by UE 115-b and network entity 105-b, the examples herein are not to be construed as limiting, as the described features may be associated with any quantity of different devices.

At 405, network entity 105-b may determine to multiplex one or more DCI components with a downlink shared data based on a quantity of the plurality of DCI components exceeding a quantity threshold, an aggregated size of the plurality DCI components exceeding a payload size threshold, or both. As a result of the comparison of the plurality DCI components satisfying the threshold, network entity 105-b may then determine to multiplex the DCI components with a downlink shared data message for output and transmission to the one or more UEs 115-b.

At 415, network entity 105-b may encode the DCI components with either LDPC or polar coding. Network entity 105-b may switch between LDPC and polar encoding schemes depending on the payload size of the DCI components and how the DCI components are bundled (i.e., jointly or separately). The switching between LDPC and polar encoding schemes may be based on a payload size threshold. This threshold may be hard coded or it may be semi-statically configured using RRC signaling.

At 420, network entity 105-b may transmit the encoded DCI components multiplexed with the downlink shared data to the one or more UEs 115-b.

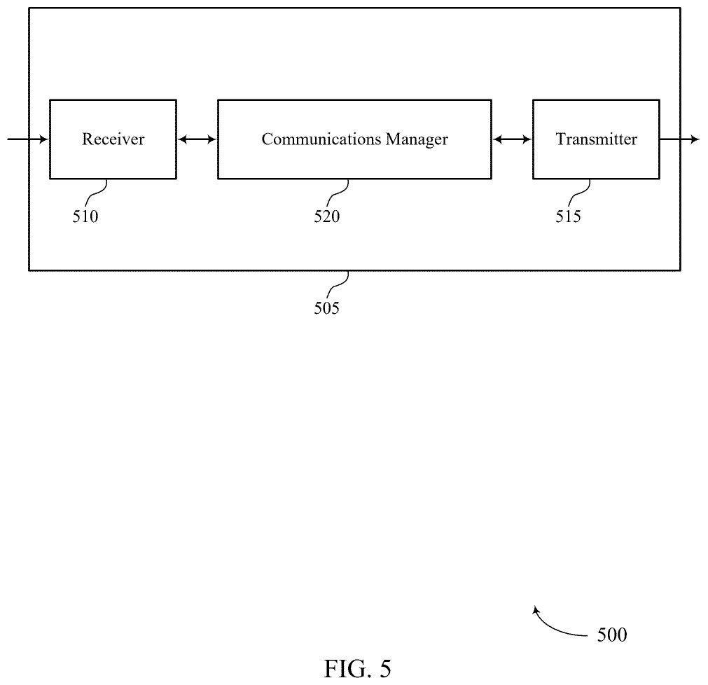

FIG. 5 shows a block diagram 500 of a device 505 that supports shared channel piggybacking in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of shared channel piggybacking as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for generating one or more DCI components for one or more UEs. The communications manager 520 is capable of, configured to, or operable to support a means for multiplexing the one or more DCI components with downlink shared data for the one or more UEs based on a quantity of the one or more DCI components exceeding a quantity threshold, an aggregated size of the one or more DCI components exceeding a payload size threshold, or both. The communications manager 520 is capable of, configured to, or operable to support a means for outputting a downlink shared channel including the one or more DCI components multiplexed with the downlink shared data for the one or more UEs.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for The techniques described herein may lead to various advantages including a more efficient utilization of communication resources due to a higher coding gain resulting from optimal coding schemes.

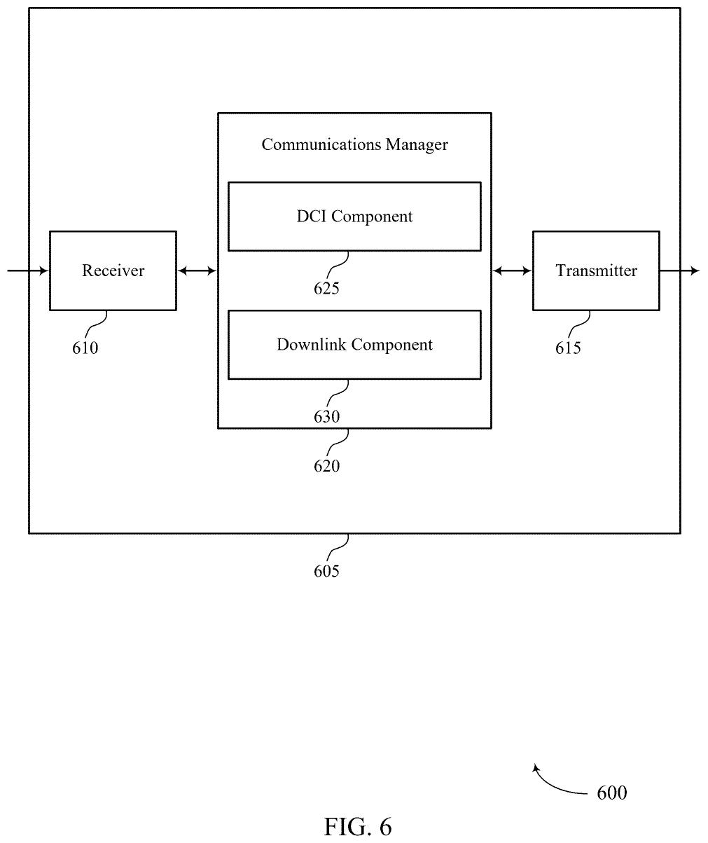

FIG. 6 shows a block diagram 600 of a device 605 that supports shared channel piggybacking in accordance with one or more aspects of the present disclosure. The device 605 may be an example of aspects of a device 505 or a network entity 105 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of shared channel piggybacking as described herein. For example, the communications manager 620 may include a DCI component 625 a Downlink component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The DCI component 625 is capable of, configured to, or operable to support a means for generating one or more DCI components for one or more UEs. The DCI component 625 is capable of, configured to, or operable to support a means for multiplexing the one or more DCI components with downlink shared data for the one or more UEs based on a quantity of the one or more DCI components exceeding a quantity threshold, an aggregated size of the one or more DCI components exceeding a payload size threshold, or both. The Downlink component 630 is capable of, configured to, or operable to support a means for outputting a downlink shared channel including the one or more DCI components multiplexed with the downlink shared data for the one or more UEs.

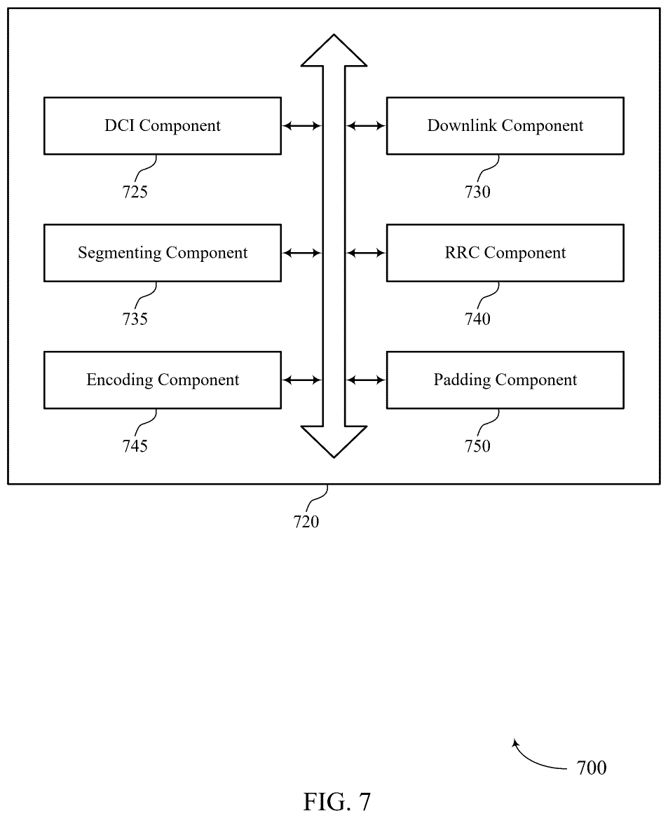

FIG. 7 shows a block diagram 700 of a communications manager 720 that supports shared channel piggybacking in accordance with one or more aspects of the present disclosure. The communications manager 720 may be an example of aspects of a communications manager 520, a communications manager 620, or both, as described herein. The communications manager 720, or various components thereof, may be an example of means for performing various aspects of shared channel piggybacking as described herein. For example, the communications manager 720 may include a DCI component 725, a Downlink component 730, a Segmenting component 735, an RRC component 740, an Encoding component 745, a Padding component 750, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The DCI component 725 is capable of, configured to, or operable to support a means for generating one or more DCI components for one or more UEs. In some examples, the DCI component 725 is capable of, configured to, or operable to support a means for multiplexing the one or more DCI components with downlink shared data for the one or more UEs based on a quantity of the one or more DCI components exceeding a quantity threshold, an aggregated size of the one or more DCI components exceeding a payload size threshold, or both. The Downlink component 730 is capable of, configured to, or operable to support a means for outputting a downlink shared channel including the one or more DCI components multiplexed with the downlink shared data for the one or more UEs.

In some examples, to support generating the one or more DCI components, the DCI component 725 is capable of, configured to, or operable to support a means for generating the one or more DCI components with a common cyclic redundancy check.

In some examples, the Encoding component 745 is capable of, configured to, or operable to support a means for encoding the one or more DCI components with a low density parity check code based on the aggregated size of the one or more DCI components exceeding the threshold, where the threshold is a payload size threshold.

In some examples, the Encoding component 745 is capable of, configured to, or operable to support a means for encoding the one or more DCI components with a polar code based on the aggregated size of the one or more DCI components being less than the threshold, where the threshold is a payload size threshold.

In some examples, to support generating the one or more DCI components, the Segmenting component 735 is capable of, configured to, or operable to support a means for segmenting an aggregation of the one or more DCI components into a set of multiple DCI segments, where each of the set of multiple DCI segments is associated with a respective cyclic redundancy check.

In some examples, the Encoding component 745 is capable of, configured to, or operable to support a means for encoding one or more DCI segments of the set of multiple DCI segments with a low density parity check code based on a respective payload size of each of the one or more DCI segments exceeding the threshold, where the threshold is a payload size threshold.

In some examples, the Encoding component 745 is capable of, configured to, or operable to support a means for encoding one or more DCI segments of the set of multiple DCI segments with a polar code based on a respective payload size of each of the one or more DCI segments being less than the threshold, where the threshold is a payload size threshold.

In some examples, the Encoding component 745 is capable of, configured to, or operable to support a means for encoding each of the set of multiple DCI segments with a low density parity check code based on a maximum payload size associated with the set of multiple DCI segments exceeding the threshold.

In some examples, the Encoding component 745 is capable of, configured to, or operable to support a means for encoding each of the set of multiple DCI segments with a polar code based on a minimum payload size of the set of multiple DCI segments being less than the threshold.

In some examples, the Padding component 750 is capable of, configured to, or operable to support a means for zero padding one or more DCI segments of the set of multiple DCI segments based on the one or more DCI segments having a different payload size than a remaining quantity of DCI segments of the set of multiple DCI segments.

In some examples, the RRC component 740 is capable of, configured to, or operable to support a means for receiving an indication of the threshold via radio resource control signaling.

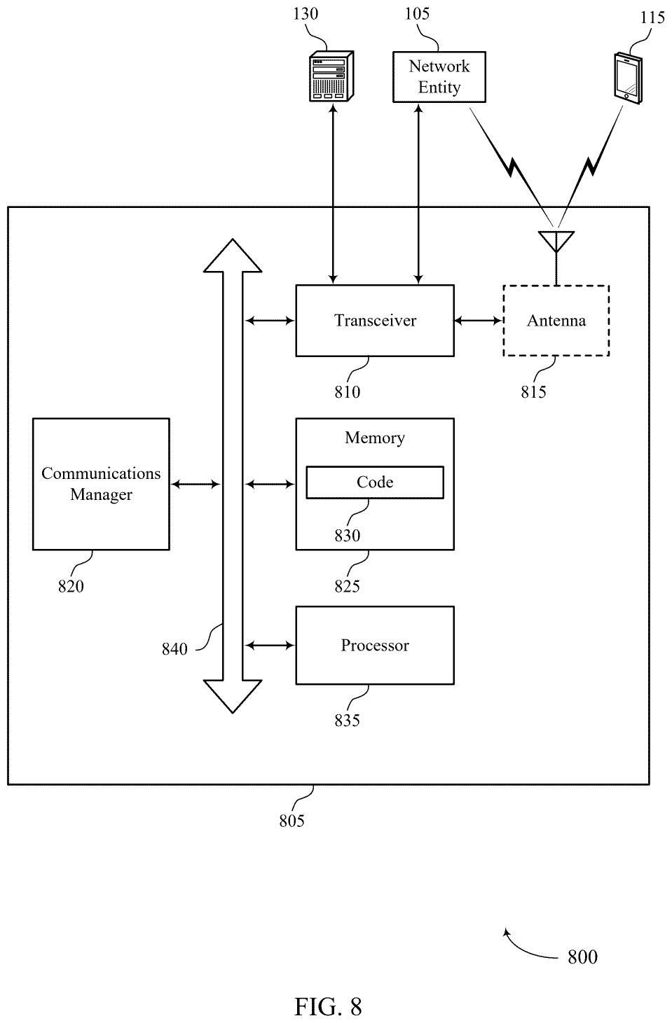

FIG. 8 shows a diagram of a system 800 including a device 805 that supports shared channel piggybacking in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting shared channel piggybacking). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for generating one or more DCI components for one or more UEs. The communications manager 820 is capable of, configured to, or operable to support a means for multiplexing the one or more DCI components with downlink shared data for the one or more UEs based on a quantity of the one or more DCI components exceeding a quantity threshold, an aggregated size of the one or more DCI components exceeding a payload size threshold, or both. The communications manager 820 is capable of, configured to, or operable to support a means for outputting a downlink shared channel including the one or more DCI components multiplexed with the downlink shared data for the one or more UEs.

By including or configuring the communications manager 820 in accordance with examples as described herein, the device 805 may support techniques for The techniques described herein may lead to various advantages including a more efficient utilization of communication resources due to a higher coding gain resulting from optimal coding schemes.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of shared channel piggybacking as described herein, or the at least one processor 835 and the at least one memory 825 may be otherwise configured to, individually or collectively, perform or support such operations.

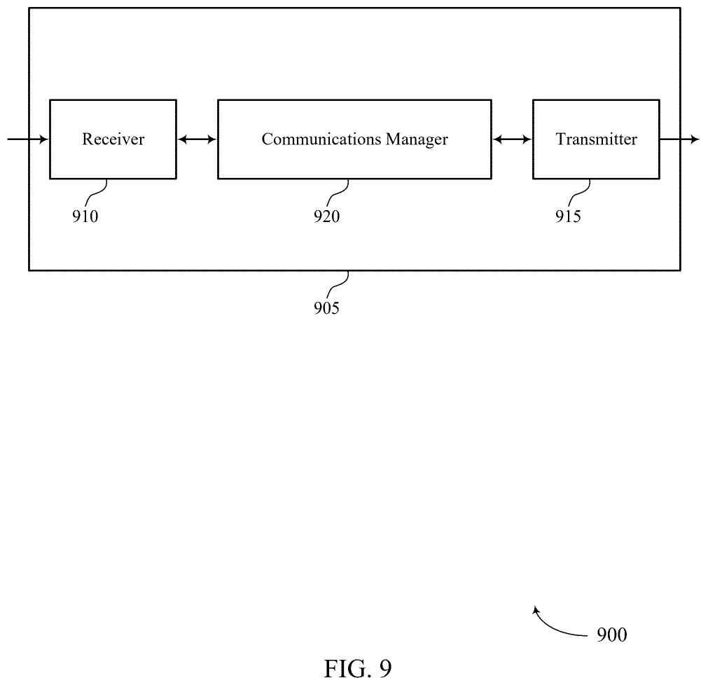

FIG. 9 shows a block diagram 900 of a device 905 that supports shared channel piggybacking in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to shared channel piggybacking). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to shared channel piggybacking). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of shared channel piggybacking as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a downlink shared channel including one or more DCI components multiplexed with downlink shared data based on a quantity of the one or more DCI components exceeding a quantity threshold, an aggregated size of the one or more DCI components exceeding a payload size threshold, or both. The communications manager 920 is capable of, configured to, or operable to support a means for decoding the one or more DCI components, the downlink shared data, or both, to obtain downlink control information, shared data, or both for the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for The techniques described herein may lead to various advantages including a more efficient utilization of communication resources due to a higher coding gain resulting from optimal coding schemes.

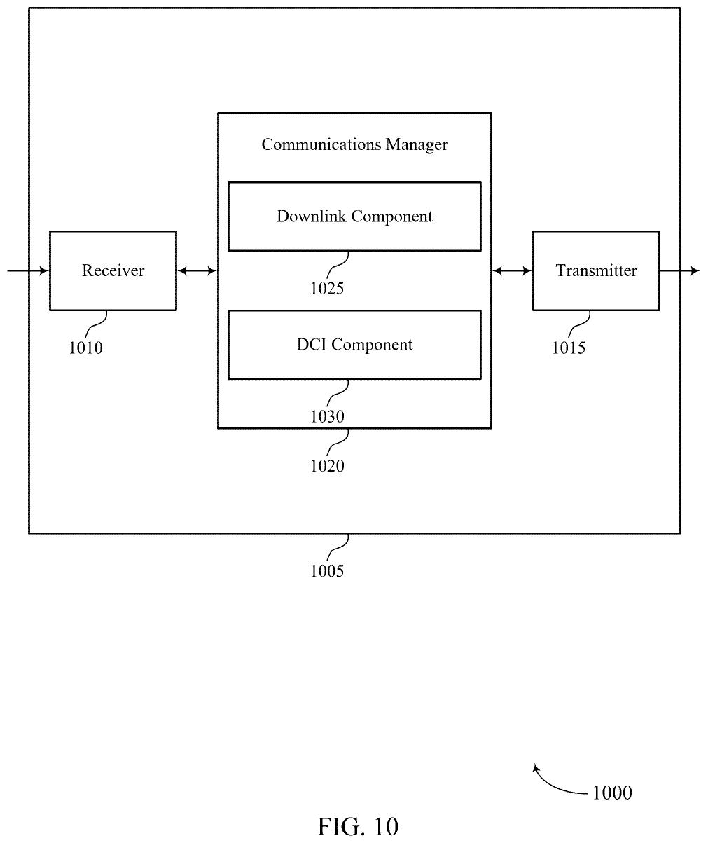

FIG. 10 shows a block diagram 1000 of a device 1005 that supports shared channel piggybacking in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to shared channel piggybacking). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to shared channel piggybacking). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of shared channel piggybacking as described herein. For example, the communications manager 1020 may include a Downlink component 1025 a DCI component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The Downlink component 1025 is capable of, configured to, or operable to support a means for receiving a downlink shared channel including one or more DCI components multiplexed with downlink shared data based on a quantity of the one or more DCI components exceeding a quantity threshold, an aggregated size of the one or more DCI components exceeding a payload size threshold, or both. The DCI component 1030 is capable of, configured to, or operable to support a means for decoding the one or more DCI components, the downlink shared data, or both, to obtain downlink control information, shared data, or both for the UE.

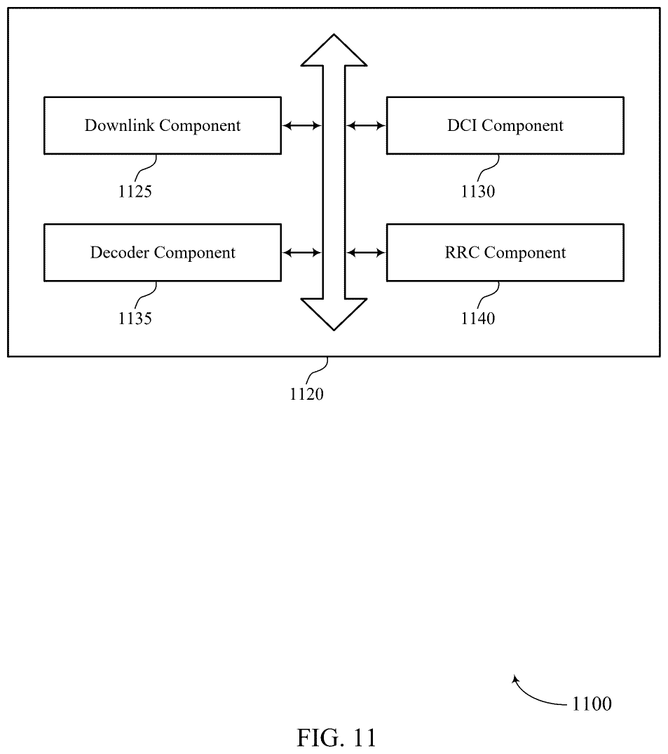

FIG. 11 shows a block diagram 1100 of a communications manager 1120 that supports shared channel piggybacking in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of shared channel piggybacking as described herein. For example, the communications manager 1120 may include a Downlink component 1125, a DCI component 1130, a Decoder component 1135, an RRC component 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The Downlink component 1125 is capable of, configured to, or operable to support a means for receiving a downlink shared channel including one or more DCI components multiplexed with downlink shared data based on a quantity of the one or more DCI components exceeding a quantity threshold, an aggregated size of the one or more DCI components exceeding a payload size threshold, or both. The DCI component 1130 is capable of, configured to, or operable to support a means for decoding the one or more DCI components, the downlink shared data, or both, to obtain downlink control information, shared data, or both for the UE.

In some examples, to support receiving the one or more DCI components, the DCI component 1130 is capable of, configured to, or operable to support a means for receiving the one or more DCI components with a common cyclic redundancy check.

In some examples, to support receiving the one or more DCI components, the Decoder component 1135 is capable of, configured to, or operable to support a means for receiving the one or more DCI components encoded with a low density parity check code, the encoding based on the aggregated size of the one or more DCI components exceeding the threshold, where the threshold is a payload size threshold.

In some examples, to support receiving the one or more DCI components, the Decoder component 1135 is capable of, configured to, or operable to support a means for receiving the one or more DCI components encoded with a polar code, the encoding based on the aggregated size of the one or more DCI components being less than the threshold, where the threshold is a payload size threshold.

In some examples, to support receiving the one or more DCI components, the DCI component 1130 is capable of, configured to, or operable to support a means for receiving the one or more DCI components via a set of multiple DCI segments, where each of the set of multiple DCI segments is associated with a respective cyclic redundancy check.

In some examples, the Decoder component 1135 is capable of, configured to, or operable to support a means for receiving one or more DCI segments of the set of multiple DCI segments encoded with a low density parity check code, the low density parity check code based on a respective payload size of each of the one or more DCI segments exceeding the threshold, where the threshold is a payload size threshold.

In some examples, the Decoder component 1135 is capable of, configured to, or operable to support a means for receiving one or more DCI segments of the set of multiple DCI segments encoded with a polar code, the polar code based on a respective payload size of each of the one or more DCI segments being less than the threshold, where the threshold is a payload size threshold.

In some examples, the Decoder component 1135 is capable of, configured to, or operable to support a means for receiving each of the set of multiple DCI segments encoded with a low density parity check code, the encoding based on a maximum payload size associated with the set of multiple DCI segments exceeding the threshold.

In some examples, the Decoder component 1135 is capable of, configured to, or operable to support a means for receiving each of the set of multiple DCI segments encoded with a polar code, the encoding based on a minimum payload size of the set of multiple DCI segments being less than the threshold.

In some examples, one or more DCI segments of the set of multiple DCI segments are zero padded based on the one or more DCI segments having a different payload size than a remaining quantity of DCI segments of the set of multiple DCI segmenting.

In some examples, the RRC component 1140 is capable of, configured to, or operable to support a means for transmitting an indication of the threshold via radio resource control signaling.

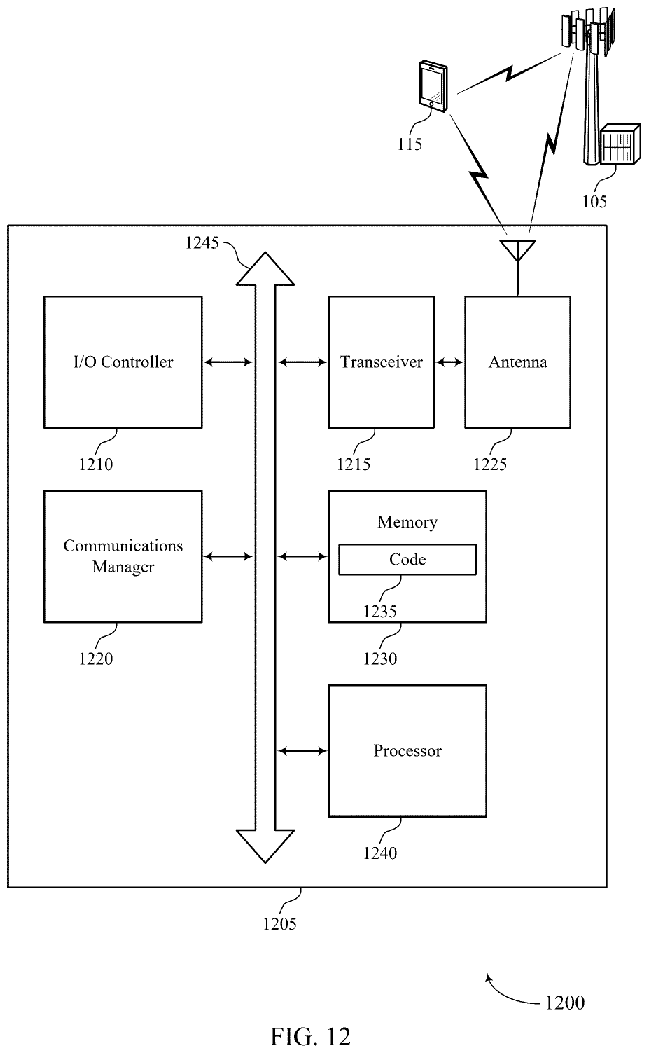

FIG. 12 shows a diagram of a system 1200 including a device 1205 that supports shared channel piggybacking in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting shared channel piggybacking). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a downlink shared channel including one or more DCI components multiplexed with downlink shared data based on a quantity of the one or more DCI components exceeding a quantity threshold, an aggregated size of the one or more DCI components exceeding a payload size threshold, or both. The communications manager 1220 is capable of, configured to, or operable to support a means for decoding the one or more DCI components, the downlink shared data, or both, to obtain downlink control information, shared data, or both for the UE.

By including or configuring the communications manager 1220 in accordance with examples as described herein, the device 1205 may support techniques for The techniques described herein may lead to various advantages including a more efficient utilization of communication resources due to a higher coding gain resulting from optimal coding schemes.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of shared channel piggybacking as described herein, or the at least one processor 1240 and the at least one memory 1230 may be otherwise configured to, individually or collectively, perform or support such operations.

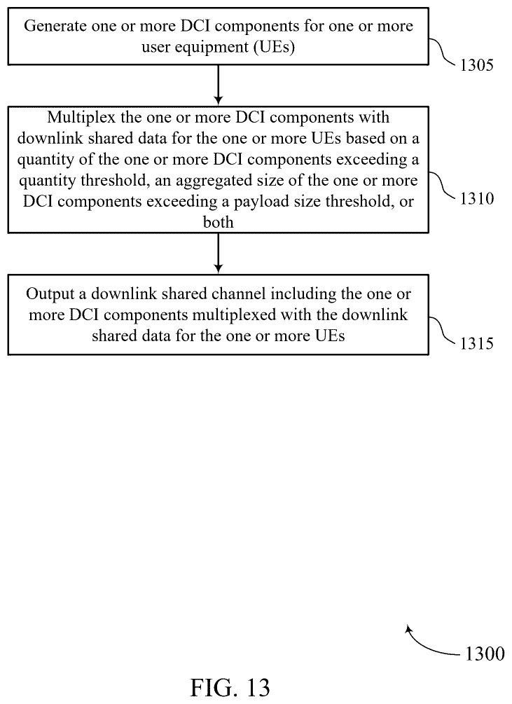

FIG. 13 shows a flowchart illustrating a method 1300 that supports shared channel piggybacking in accordance with one or more aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include generating one or more DCI components for one or more UEs. The operations of 1305 may be performed in accordance with examples as disclosed herein. In some examples, aspects of the operations of 1305 may be performed by a DCI component 725 as described with reference to FIG. 7.

At 1310, the method may include multiplexing the one or more DCI components with downlink shared data for the one or more UEs based on a quantity of the one or more DCI components exceeding a quantity threshold, an aggregated size of the one or more DCI components exceeding a payload size threshold, or both. The operations of 1310 may be performed in accordance with examples as disclosed herein. In some examples, aspects of the operations of 1310 may be performed by a DCI component 725 as described with reference to FIG. 7.

At 1315, the method may include outputting a downlink shared channel including the one or more DCI components multiplexed with the downlink shared data for the one or more UEs. The operations of 1315 may be performed in accordance with examples as disclosed herein. In some examples, aspects of the operations of 1315 may be performed by a Downlink component 730 as described with reference to FIG. 7.

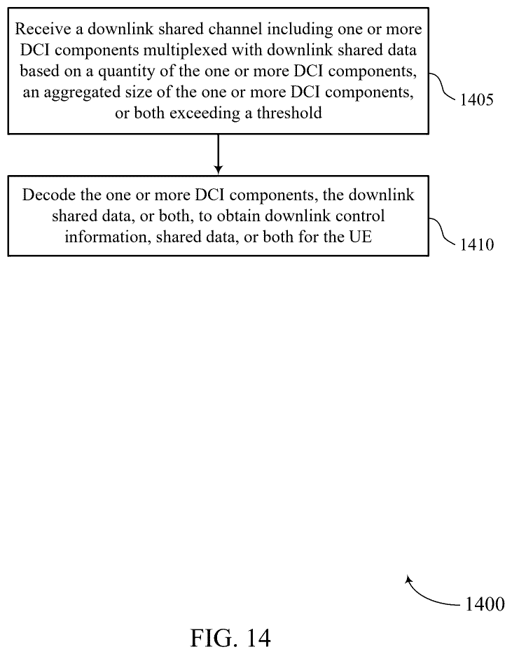

FIG. 14 shows a flowchart illustrating a method 1400 that supports shared channel piggybacking in accordance with one or more aspects of the present disclosure. The operations of the method 1400 may be implemented by a UE or its components as described herein. For example, the operations of the method 1400 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1405, the method may include receiving a downlink shared channel including one or more DCI components multiplexed with downlink shared data based on a quantity of the one or more DCI components exceeding a quantity threshold, an aggregated size of the one or more DCI components exceeding a payload size threshold, or both. The operations of 1405 may be performed in accordance with examples as disclosed herein. In some examples, aspects of the operations of 1405 may be performed by a Downlink component 1125 as described with reference to FIG. 11.

At 1410, the method may include decoding the one or more DCI components, the downlink shared data, or both, to obtain downlink control information, shared data, or both for the UE. The operations of 1410 may be performed in accordance with examples as disclosed herein. In some examples, aspects of the operations of 1410 may be performed by a DCI component 1130 as described with reference to FIG. 11.

The following provides an overview of aspects of the present disclosure:

Aspect 1: A method for wireless communications at a network entity, comprising: generating one or more DCI components for one or more UEs; multiplexing the one or more DCI components with downlink shared data for the one or more UEs based at least in part on a quantity of the one or more DCI components exceeding a quantity threshold, an aggregated size of the one or more DCI components exceeding a payload size threshold, or both; and outputting a downlink shared channel comprising the one or more DCI components multiplexed with the downlink shared data for the one or more UEs.

Aspect 2: The method of aspect 1, wherein generating the one or more DCI components comprises: generating the one or more DCI components with a common cyclic redundancy check.

Aspect 3: The method of aspect 2, further comprising: encoding the one or more DCI components with a low density parity check code based at least in part on the aggregated size of the one or more DCI components exceeding the payload size threshold.

Aspect 4: The method of any of aspects 2 through 3, further comprising: encoding the one or more DCI components with a polar code based at least in part on the aggregated size of the one or more DCI components being less than the payload size threshold.

Aspect 5: The method of any of aspects 1 through 4, wherein generating the one or more DCI components comprises: segmenting an aggregation of the one or more DCI components into a plurality of DCI segments, wherein each of the plurality of DCI segments is associated with a respective cyclic redundancy check.

Aspect 6: The method of aspect 5, further comprising: encoding one or more DCI segments of the plurality of DCI segments with a low density parity check code based at least in part on a respective payload size of each of the one or more DCI segments exceeding the payload size threshold.

Aspect 7: The method of any of aspects 5 through 6, further comprising: encoding one or more DCI segments of the plurality of DCI segments with a polar code based at least in part on a respective payload size of each of the one or more DCI segments being less than the payload size threshold.

Aspect 8: The method of any of aspects 5 through 7, further comprising: encoding each of the plurality of DCI segments with a low density parity check code based at least in part on a maximum payload size associated with the plurality of DCI segments exceeding the payload size threshold.

Aspect 9: The method of any of aspects 5 through 8, further comprising: encoding each of the plurality of DCI segments with a polar code based at least in part on a minimum payload size of the plurality of DCI segments being less than the payload size threshold.

Aspect 10: The method of any of aspects 5 through 9, further comprising: zero padding one or more DCI segments of the plurality of DCI segments based at least in part on the one or more DCI segments having a different payload size than a remaining quantity of DCI segments of the plurality of DCI segments.

Aspect 11: The method of any of aspects 1 through 10, further comprising: receiving an indication of the threshold via radio resource control signaling.

Aspect 12: A method for wireless communications at a UE, comprising: receiving a downlink shared channel comprising one or more DCI components multiplexed with downlink shared data based at least in part on a quantity of the one or more DCI components exceeding a quantity threshold, an aggregated size of the one or more DCI components exceeding a payload size threshold, or both; and decoding the one or more DCI components, the downlink shared data, or both, to obtain downlink control information, shared data, or both for the UE.

Aspect 13: The method of aspect 12, wherein receiving the one or more DCI components comprises: receiving the one or more DCI components with a common cyclic redundancy check.

Aspect 14: The method of aspect 13, wherein receiving the one or more DCI components comprises: receiving the one or more DCI components encoded with a low density parity check code, the encoding based at least in part on the aggregated size of the one or more DCI components exceeding the payload size threshold.

Aspect 15: The method of any of aspects 13 through 14, wherein receiving the one or more DCI components comprises: receiving the one or more DCI components encoded with a polar code, the encoding based at least in part on the aggregated size of the one or more DCI components being less than the payload size threshold.

Aspect 16: The method of any of aspects 12 through 15, wherein receiving the one or more DCI components comprises: receiving the one or more DCI components via a plurality of DCI segments, wherein each of the plurality of DCI segments is associated with a respective cyclic redundancy check.

Aspect 17: The method of aspect 16, further comprising: receiving one or more DCI segments of the plurality of DCI segments encoded with a low density parity check code, the low density parity check code based at least in part on a respective payload size of each of the one or more DCI segments exceeding the payload size threshold.

Aspect 18: The method of any of aspects 16 through 17, further comprising: receiving one or more DCI segments of the plurality of DCI segments encoded with a polar code, the polar code based at least in part on a respective payload size of each of the one or more DCI segments being less than the payload size threshold.

Aspect 19: The method of any of aspects 16 through 18, further comprising: receiving each of the plurality of DCI segments encoded with a low density parity check code, the encoding based at least in part on a maximum payload size associated with the plurality of DCI segments exceeding the payload size threshold.

Aspect 20: The method of any of aspects 16 through 19, further comprising: receiving each of the plurality of DCI segments encoded with a polar code, the encoding based at least in part on a minimum payload size of the plurality of DCI segments being less than the payload size threshold.

Aspect 21: The method of any of aspects 16 through 20, wherein one or more DCI segments of the plurality of DCI segments are zero padded based at least in part on the one or more DCI segments having a different payload size than a remaining quantity of DCI segments of the plurality of DCI segmenting.

Aspect 22: The method of any of aspects 16 through 21, further comprising: transmitting an indication of the threshold via radio resource control signaling.

Aspect 23: A network entity for wireless communications, comprising one or more memories storing processor-executable code, and one or more processors coupled with the one or more memories and individually or collectively operable to execute the code to cause the network entity to perform a method of any of aspects 1 through 11.

Aspect 24: A network entity for wireless communications, comprising at least one means for performing a method of any of aspects 1 through 11.

Aspect 25: A non-transitory computer-readable medium storing code for wireless communications, the code comprising instructions executable by one or more processors to perform a method of any of aspects 1 through 11.

Aspect 26: A UE for wireless communications, comprising one or more memories storing processor-executable code, and one or more processors coupled with the one or more memories and individually or collectively operable to execute the code to cause the UE to perform a method of any of aspects 12 through 22.

Aspect 27: A UE for wireless communications, comprising at least one means for performing a method of any of aspects 12 through 22.

Aspect 28: A non-transitory computer-readable medium storing code for wireless communications, the code comprising instructions executable by one or more processors to perform a method of any of aspects 12 through 22. It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
generate one or more downlink control information (DCI) components for one or more user equipment (UEs);
multiplex the one or more DCI components with downlink shared data for the one or more UEs based at least in part on a quantity of the one or more DCI components exceeding a quantity threshold, an aggregated size of the one or more DCI components exceeding a payload size threshold, or both; and
output a downlink shared channel comprising the one or more DCI components multiplexed with the downlink shared data for the one or more UEs.

2. The network entity of claim 1, wherein, to generate the one or more DCI components, the one or more processors are individually or collectively operable to execute the code to cause the network entity to:
generate the one or more DCI components with a common cyclic redundancy check.

3. The network entity of claim 2, wherein the one or more processors are individually or collectively further operable to execute the code to cause the network entity to:
encode the one or more DCI components with a low density parity check code based at least in part on the aggregated size of the one or more DCI components exceeding the payload size threshold.

4. The network entity of claim 2, wherein the one or more processors are individually or collectively further operable to execute the code to cause the network entity to:
encode the one or more DCI components with a polar code based at least in part on the aggregated size of the one or more DCI components being less than the payload size threshold.

5. The network entity of claim 1, wherein, to generate the one or more DCI components, the one or more processors are individually or collectively operable to execute the code to cause the network entity to:
segment an aggregation of the one or more DCI components into a plurality of DCI segments, wherein each of the plurality of DCI segments is associated with a respective cyclic redundancy check.

6. The network entity of claim 5, wherein the one or more processors are individually or collectively further operable to execute the code to cause the network entity to:
encode one or more DCI segments of the plurality of DCI segments with a low density parity check code based at least in part on a respective payload size of each of the one or more DCI segments exceeding the payload size threshold.

7. The network entity of claim 5, wherein the one or more processors are individually or collectively further operable to execute the code to cause the network entity to:
encode one or more DCI segments of the plurality of DCI segments with a polar code based at least in part on a respective payload size of each of the one or more DCI segments being less than the payload size threshold.

8. The network entity of claim 5, wherein the one or more processors are individually or collectively further operable to execute the code to cause the network entity to:
encode each of the plurality of DCI segments with a low density parity check code based at least in part on a maximum payload size associated with the plurality of DCI segments exceeding the payload size threshold.

9. The network entity of claim 5, wherein the one or more processors are individually or collectively further operable to execute the code to cause the network entity to:
encode each of the plurality of DCI segments with a polar code based at least in part on a minimum payload size of the plurality of DCI segments being less than the payload size threshold.

10. The network entity of claim 5, wherein the one or more processors are individually or collectively further operable to execute the code to cause the network entity to:
zero padding one or more DCI segments of the plurality of DCI segments base at least in part on the one or more DCI segments having a different payload size than a remaining quantity of DCI segments of the plurality of DCI segments.

11. The network entity of claim 1, wherein the one or more processors are individually or collectively further operable to execute the code to cause the network entity to:
receive an indication of the quantity threshold and the payload size threshold via radio resource control signaling.

12. A user equipment (UE), comprising:
one or more memories storing processor-executable code; and
one or more processors coupled with the one or more memories and individually or collectively operable to execute the code to cause the UE to:
receive a downlink shared channel comprising one or more downlink control information (DCI) components multiplexed with downlink shared data based at least in part on a quantity of the one or more DCI components exceeding a quantity threshold, an aggregated size of the one or more DCI components exceeding a payload size threshold, or both; and
decode the one or more DCI components, the downlink shared data, or both, to obtain downlink control information, shared data, or both for the UE.

13. The UE of claim 12, wherein, to receive the one or more DCI components, the one or more processors are individually or collectively operable to execute the code to cause the UE to:
receive the one or more DCI components with a common cyclic redundancy check.

14. The UE of claim 13, wherein, to receive the one or more DCI components, the one or more processors are individually or collectively operable to execute the code to cause the UE to:
receive the one or more DCI components encoded with a low density parity check code, the encoding based at least in part on the aggregated size of the one or more DCI components exceeding the payload size threshold.

15. The UE of claim 13, wherein, to receive the one or more DCI components, the one or more processors are individually or collectively operable to execute the code to cause the UE to:
receive the one or more DCI components encoded with a polar code, the encoding based at least in part on the aggregated size of the one or more DCI components being less than the payload size threshold.

16. The UE of claim 12, wherein, to receive the one or more DCI components, the one or more processors are individually or collectively operable to execute the code to cause the UE to:
receive the one or more DCI components via a plurality of DCI segments, wherein each of the plurality of DCI segments is associated with a respective cyclic redundancy check.

17. The UE of claim 16, wherein the one or more processors are individually or collectively further operable to execute the code to cause the UE to:
receive one or more DCI segments of the plurality of DCI segments encoded with a low density parity check code, the low density parity check code based at least in part on a respective payload size of each of the one or more DCI segments exceeding the payload size threshold.

18. The UE of claim 16, wherein the one or more processors are individually or collectively further operable to execute the code to cause the UE to:
receive one or more DCI segments of the plurality of DCI segments encoded with a polar code, the polar code based at least in part on a respective payload size of each of the one or more DCI segments being less than the payload size threshold.

19. The UE of claim 16, wherein the one or more processors are individually or collectively further operable to execute the code to cause the UE to:
receive each of the plurality of DCI segments encoded with a low density parity check code, the encoding based at least in part on a maximum payload size associated with the plurality of DCI segments exceeding the payload size threshold.

20. The UE of claim 16, wherein the one or more processors are individually or collectively further operable to execute the code to cause the UE to:
receive each of the plurality of DCI segments encoded with a polar code, the encoding based at least in part on a minimum payload size of the plurality of DCI segments being less than the payload size threshold.

21. The UE of claim 16, wherein one or more DCI segments of the plurality of DCI segments are zero padded based at least in part on the one or more DCI segments having a different payload size than a remaining quantity of DCI segments of the plurality of DCI segmenting.

22. The UE of claim 16, wherein the one or more processors are individually or collectively further operable to execute the code to cause the UE to:
transmit an indication of the quantity threshold and the payload size threshold via radio resource control signaling.

23. A method for wireless communications at a network entity, comprising:
generating one or more downlink control information (DCI) components for one or more user equipment (UEs);
multiplexing the one or more DCI components with downlink shared data for the one or more UEs based at least in part on a quantity of the one or more DCI components exceeding a quantity threshold, an aggregated size of the one or more DCI components exceeding a payload size threshold, or both; and
outputting a downlink shared channel comprising the one or more DCI components multiplexed with the downlink shared data for the one or more UEs.

24. The method of claim 23, wherein generating the one or more DCI components comprises:
generating the one or more DCI components with a common cyclic redundancy check.

25. The method of claim 24, further comprising:
encoding the one or more DCI components with a low density parity check code based at least in part on the aggregated size of the one or more DCI components exceeding the payload size threshold.

26. The method of claim 23, wherein generating the one or more DCI components comprises:
segmenting an aggregation of the one or more DCI components into a plurality of DCI segments, wherein each of the plurality of DCI segments is associated with a respective cyclic redundancy check.

27. A method for wireless communications at a user equipment (UE), comprising:
receiving a downlink shared channel comprising one or more downlink control information (DCI) components multiplexed with downlink shared data based at least in part on a quantity of the one or more DCI components exceeding a quantity threshold, an aggregated size of the one or more DCI components exceeding a payload size threshold, or both; and
decoding the one or more DCI components, the downlink shared data, or both, to obtain downlink control information, shared data, or both for the UE.

28. The method of claim 27, wherein receiving the one or more DCI components comprises:
receiving the one or more DCI components with a common cyclic redundancy check.

29. The method of claim 28, wherein receiving the one or more DCI components comprises:
receiving the one or more DCI components encoded with a low density parity check code, the encoding based at least in part on the aggregated size of the one or more DCI components exceeding the payload size threshold.

30. The method of claim 27, wherein receiving the one or more DCI components comprises:
receiving the one or more DCI components via a plurality of DCI segments, wherein each of the plurality of DCI segments is associated with a respective cyclic redundancy check.
